(19) United States
(12) Patent Application Publication
(10) Pub. No.: US 2010/0195065 A1
(43) Pub. Date: Aug. 5, 2010

(54) Exposure apparatuses

(75) Inventors: Sang Joon Hong, Suwon-si (KR); In Bae Jang, Seoul (KR); Oui Serg Kim, Seoul (KR); Sung Jin Lee, Hwaseong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/656,171

(22) Filed: Jan. 20, 2010

(30) Foreign Application Priority Data
Feb. 2, 2009 (KR) 10-2009-0007816

(51) Int. Cl. G03B 27/00

(52) U.S. Cl. 355/2

(57) ABSTRACT

An exposure apparatus may include a light source generating light; a hologram mask, on which a hologram pattern is formed; and an optical unit movably disposed on the hologram mask to guide the light generated from the light source to the hologram mask. An exposure apparatus may include a light source generating light; a hologram mask, on which a hologram pattern is formed; a prism, separated from the hologram mask, such that one surface of the prism is disposed opposite the hologram mask; and a water supply device to supply water to a space between the prism and the hologram mask.

### CROSS-REFERENCE TO RELATED APPLICATION(S)

This application claims priority from Korean Patent Application No. 10-2009-0007816, filed on Feb. 2, 2009, in the Korean Intellectual Property Office (KIPO), the entire contents of which are incorporated herein by reference.

### BACKGROUND

1. Field

Example embodiments relate to exposure apparatuses. Also, example embodiments relate to holographic lithography-type exposure apparatuses.

2. Description of the Related Art

In general, exposure apparatuses may be apparatuses that align a mask provided with a pattern on a substrate with a photoresist layer formed on the surface thereof, and/or irradiate light onto the photoresist layer of the substrate through the mask to form a pattern corresponding to the mask on the photoresist layer.

Among these exposure apparatuses, there may be a holographic lithography-type exposure apparatus that may form a hologram pattern on a photoresist layer of a substrate through a hologram mask provided with a hologram pattern.

The conventional exposure apparatus using holographic lithography may include a light source to generate light, the hologram mask provided with the hologram pattern, and/or a prism, one surface of which may be adhered to the hologram mask.

In the above conventional exposure apparatus, an exposure process may be carried out under the condition that the hologram mask may be adhered to one surface of the prism through an index matching liquid having the same refractive index as that of the prism. In order to adhere the hologram mask to the prism, the prism may have a size corresponding to that of the hologram mask. Therefore, the size of the prism may be increased to increase the size of the hologram mask, and thereby the exposure apparatus may inevitably become larger.

Further, since the prism and the hologram mask in the conventional exposure apparatus may be adhered to each other through the index matching liquid, if the hologram mask needs to be replaced, after the prism and the hologram mask may be separated from each other and/or the index matching liquid may be completely removed from the prism using a surfactant, a new hologram mask may be adhered to the prism. Therefore, the replacement operation of the hologram mask may be very complicated.

### SUMMARY

Example embodiments may provide exposure apparatuses that do not exceed maintain designated size regardless of a size of a hologram mask.

Example embodiments may provide exposure apparatuses that allow a first hologram mask to be more easily replaced with a second hologram mask.

Additional aspects of example embodiments may be set forth in part in the description that follows and, in part, will be obvious from the description and/or may be learned by practice of example embodiments.

According to example embodiments, an exposure apparatus may include a light source generating light, a hologram mask, on which a hologram pattern may be formed, and/or an optical unit movably disposed on the hologram mask in order to guide the light generated from the light source to the hologram mask.

The optical unit may include a prism separated from the hologram mask such that one surface of the prism is disposed opposite the hologram mask, and/or an optical frame, in which the prism may be mounted, that may be movably disposed on the hologram mask.

The exposure apparatus may further include a water supply device to supply water to a space between the prism and the hologram mask.

The water supply device may include a storage chamber located at a higher position than that of the space between the prism and the hologram mask in order to supply water to the space between the prism and the hologram mask by a water head difference.

The water supply device may further include a pump to supply water to the storage chamber, and/or a division member to divide the lower space of the storage chamber into a storage part, to store water, and a supply part, to allow water to be supplied to the space between the prism and the hologram mask due to the water head difference.

A water supply hole, to which water supplied by the pump is transmitted, may be provided in the storage part, and/or a drain hole to allow water to be supplied to the space between the prism and the hologram mask, may be provided in the supply part.

The water supply device may further include a water level sensor disposed in the supply part in order to measure the level of water filling the supply part.

The optical unit may further include a sealing member disposed at the outside of the prism of the optical frame in order to prevent leakage of water supplied to the space between the prism and the hologram mask.

The sealing member may be provided with a sealing part. The sealing part may be formed in a labyrinthine shape.

The sealing member may be provided with a positive pressure part, the inside of which may maintain positive pressure, and/or a positive pressure channel, to which positive pressure may be transmitted. The positive pressure channel may be connected to the upper surface of the positive pressure part.

The sealing member may be provided with a negative pressure part, the inside of which may maintain negative pressure.

A negative pressure channel, to which negative pressure may be transmitted, may be connected to the upper surface of the negative pressure part, and/or a guide plane, extended to slope upwardly, may be provided at one side of the negative pressure part located at the prism.

An anti-wetting layer may be provided on the guide plane. The anti-wetting layer may include a hydrophobic material.

According to example embodiments, an exposure apparatus may include a light source generating light, a hologram mask, on which a hologram pattern may be formed, a prism separated from the hologram mask such that one surface of the prism may be disposed opposite the hologram mask, and/or a water supply device in order to supply water to a space between the prism and the hologram mask.

The water supply device may include a storage chamber located at a higher position than that of the space between the prism and the hologram mask in order to supply water to the space between the prism and the hologram mask by a water head difference.

The water supply device may further include a pump to supply water to the storage chamber, a division member to divide the lower space of the storage chamber into a storage part to store water and a supply part to allow water to be supplied to the space between the prism and the hologram mask due to the water head difference, and/or a water level sensor disposed in the supply part in order to measure the level of water filling the supply part.

The exposure apparatus may further include an optical frame, in which the prism is mounted, movably disposed on the hologram mask, and/or a sealing member disposed at the outside of the prism of the optical frame to prevent leakage of water supplied to the space between the prism and the hologram mask.

According to example embodiments, an exposure apparatus may include a light source generating light; a hologram mask, on which a hologram pattern is formed; and/or an optical unit movably disposed on the hologram mask to guide the light generated from the light source to the hologram mask.

According to example embodiments, an exposure apparatus may include a light source generating light; a hologram mask, on which a hologram pattern is formed; a prism, separated from the hologram mask, such that one surface of the prism is disposed opposite the hologram mask; and/or a water supply device to supply water to a space between the prism and the hologram mask.

### BRIEF DESCRIPTION OF THE DRAWINGS

These and/or other aspects and advantages will become more apparent and more readily appreciated from the following detailed description of example embodiments, taken in conjunction with the accompanying drawings, in which:

FIG. 1 is a schematic view illustrating the configuration of an exposure apparatus in accordance with example embodiments; and

FIG. 2 is a longitudinal-sectional view illustrating the configuration of an optical unit of the exposure apparatus in accordance with example embodiments.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

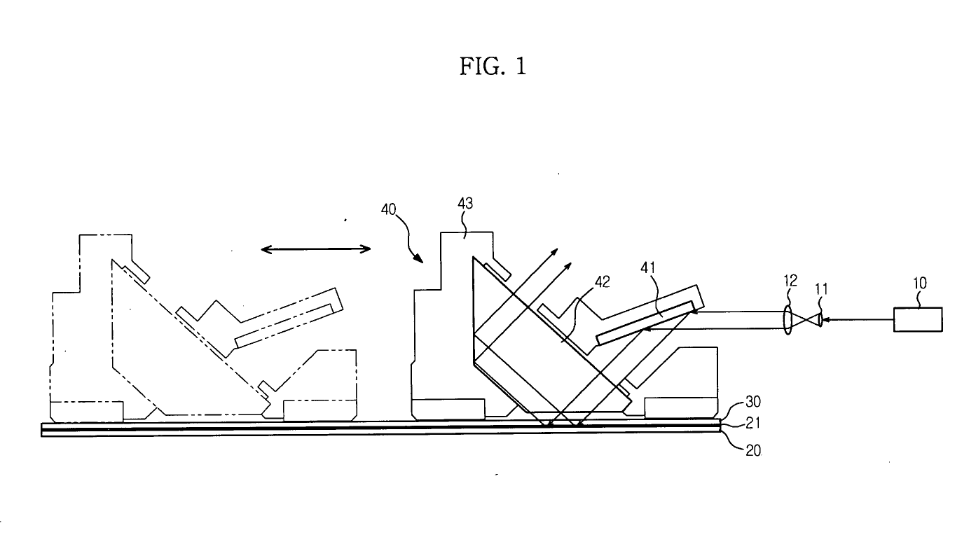

As shown in FIG. 1, an exposure apparatus according to example embodiments may serve to form a hologram pattern on substrate 20 provided with photoresist layer 21 formed on one surface of substrate 20. The exposure apparatus may include light source 10 in order to generate light, focusing lens 11, image pickup lens 12 in order to magnify light generated from light source 10, hologram mask 30 provided with a hologram pattern corresponding to the hologram pattern to be formed on substrate 20 and/or disposed on substrate 20, and/or optical unit 40 to allow the light generated from light source 10 to be irradiated onto photoresist layer 21 through hologram mask 30.

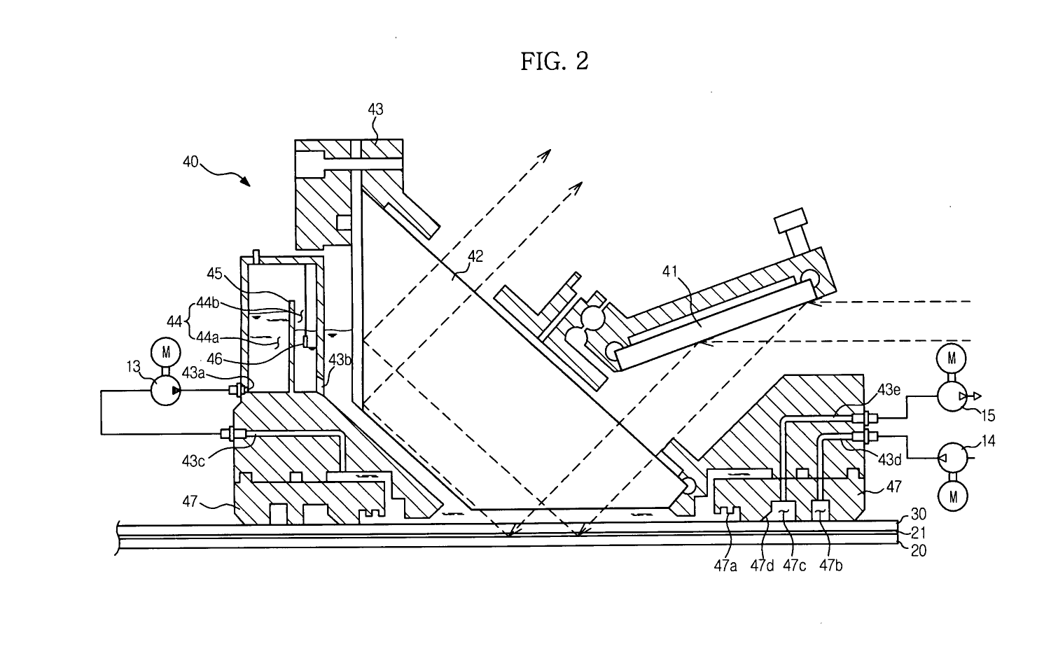

Optical unit 40, as shown in FIG. 2, may include mirror 41 to guide light magnified by focusing lens 11 and/or image pickup lens 12 to hologram mask 30, prism 42 provided with one surface disposed opposite hologram mask 30, and/or optical frame 43, in which mirror 41 and/or prism 42 may be mounted, movably disposed on hologram mask 30. If optical frame 43 is movably disposed on hologram mask 30 such that optical unit 40 moves on hologram mask 30, optical unit 40 may move and/or may irradiate light onto photoresist layer 21 of substrate 20 according to portions of photoresist layer 21, and thus the portions of photoresist layer 21 may be sequentially exposed to the light. Therefore, even if the size of hologram mask 30 is increased, optical unit 40 may be decreased to a designated size or less.

Since optical unit 40 may move on hologram mask 30, as described above, prism 42 and hologram mask 30 may be separated from each other so as to prevent friction between prism 42 and hologram mask 30 in the process of moving optical unit 40.

If prism 42 and hologram mask 30 are separated from each other, light between prism 42 and hologram mask 30 may be totally reflected. In order to prevent total reflection, a space between prism 42 and hologram mask 30 may be filled with water, and/or the exposure apparatus may include a water supply device to supply water to the space between prism 42 and hologram mask 30.

The water supply device may include storage chamber 44 provided in optical frame 43 to store water, and/or pump 13 to supply water to storage chamber 44. If water serving as an index matching liquid is supplied to the space between prism 42 and hologram mask 30, as described above, it may be unnecessary to carry out a process of removing the index matching liquid when hologram mask 30 is replaced with a new one, Thus, hologram mask 30 may be simply replaced with the new one.

Further, storage chamber 44 may be located at a higher position than that of the space between prism 42 and hologram mask 30 to supply water to the space between prism 42 and hologram mask 30 due to a water head difference. Division member 45, to divide the lower space of storage chamber 44, may be provided at the lower portion of storage chamber 44 and thus may divide the lower space of storage chamber 44 into storage part 44a to store water and supply part 44b to allow water to be supplied to the space between prism 42 and hologram mask 30 due to the water head difference.

Water supply hole 43a, to receive water from pump 13, may be provided in storage part 44a. Drain hole 43b, to allow water to be supplied to the space between prism 42 and hologram mask 30, may be provided in supply part 44b. An inlet side of pump 13 may be connected to water suction channel 43c to allow water in the space between prism 42 and hologram mask 30 to be sucked into pump 13. An outlet side of pump 13 may be connected to water supply hole 43a. Water level sensor 46, to measure the level of water filling supply part 44b, may be disposed in supply part 44b of storage chamber 44. Pump 13 may be operated according to the level of water filling supply part 44b.

Therefore, when water level sensor 46 may sense that the level of water filling supply part 44b is not higher than a designated height, pump 13 may be operated and/or may supply water to storage part 44a. The water in storage part 44a may be supplied to supply part 44b over division member 45. The water in supply part 44b may be supplied to the space between prism 42 and hologram mask 30 through drain hole 43b due to the water head difference. The water in the space between prism 42 and hologram mask 30 may be transmitted again to pump 13 through water suction channel 43c. Thus, is the water may be circulated.

When storage chamber 44 is divided into storage part 44a and supply part 44b through division member 45, as described above, pulsation according to the operation of pump 13 may be transmitted to water contained in storage part 44a, but this pulsation may not be transmitted to water contained in supply part 44b. Therefore, an influence of the pulsation on refraction of light passing through the space between prism 42 and hologram mask 30 due to the transmission of the pulsation to the space between prism 42 and hologram mask 30 may be reduced or prevented.

Further, sealing member 47 may be disposed at the outside of prism 42 of optical frame 43 to prevent leakage of water supplied to the space between prism 42 and hologram mask 30. Sealing member 47 may be provided with sealing part 47a formed in a labyrinthine shape on the lower surface of sealing member 47, disposed opposite hologram mask 30 and/or contacting hologram mask 30, to prevent leakage of water through a space between sealing member 47 and hologram mask 30. Sealing member 47 may be provided with positive pressure part 47b, formed in a concave shape such that the inside of positive pressure part 47b may maintain positive pressure to allow optical unit 40 to be easily moved on hologram mask 30. Sealing member 47 may be provided with negative pressure part 47c, formed in a concave shape such that the inside of negative pressure part 47c may maintain negative pressure to discharge air injected into positive pressure part 47b to the outside.

Positive pressure channel 43d, to which positive pressure from air compressor 14 may be transmitted, may be connected to the upper surface of positive pressure part 47b, and/or negative pressure channel 43e, to which negative pressure from vacuum pump 15 may be transmitted, may be connected to the upper surface of negative pressure part 47c. Further, guide plane 47d, extended to slope upwardly so as to guide water leaked via sealing part 47a to negative pressure channel 43e, may be provided on the upper surface of negative pressure part 47c and/or may be provided at one side of negative pressure part 47c located at prism 42. An anti-wetting layer may be provided on guide plane 47d. The anti-wetting layer may include hydrophobic material. The anti-wetting layer may be provided, for example, by a coating of Teflon®. The anti-wetting layer may prevent water from remaining on guide plane 47d and/or may allow water to smoothly move to negative pressure channel 43e. Therefore, air injected into positive pressure part 47b and/or water leaked to negative channel 47c through sealing part 47a may be discharged to the outside through negative pressure channel 43e.

As is apparent from the above description, in the exposure apparatus according to example embodiments, the optical unit may move on the hologram mask to perform an exposure process, and thus the optical unit and the prism mounted on the optical unit, respectively, may maintain designated sizes or less regardless of the size of the hologram mask.

Further, in the exposure apparatus according to example embodiments, since water filling the space between the prism and the hologram mask, that may be separated from each other, may serve as an index matching liquid, it may not be necessary to remove the index matching liquid. Thus, the hologram mask may simply be replaced with a new one.

While example embodiments have been particularly shown and described, it will be understood by those of ordinary skill in the art that various changes in form and details may be made therein without departing from the spirit and scope of the present invention as defined by the following claims.

What is claimed is:

1. An exposure apparatus, comprising:
a light source generating light;
a hologram mask, on which a hologram pattern is formed; and
an optical unit movably disposed on the hologram mask to guide the light generated from the light source to the hologram mask.

2. The exposure apparatus of claim 1, wherein the optical unit includes a prism, separated from the hologram mask, such that one surface of the prism is disposed opposite the hologram mask, and an optical frame, in which the prism is mounted, movably disposed on the hologram mask.

3. The exposure apparatus of claim 2, further comprising a water supply device to supply water to a space between the prism and the hologram mask.

4. The exposure apparatus of claim 3, wherein the water supply device includes a storage chamber, located at a higher position than that of the space between the prism and the hologram mask, to supply the water to the space between the prism and the hologram mask due to a water head difference.

5. The exposure apparatus of claim 4, wherein the water supply device further includes a pump to supply water to the storage chamber, and a division member to divide a lower space of the storage chamber into a storage part to store water and a supply part to allow the water to be supplied to the space between the prism and the hologram mask due to the water head difference.

6. The exposure apparatus of claim 5, wherein a water supply hole, to which water supplied by the pump is transmitted, is provided in the storage part, and a drain hole, to allow the water to be supplied to the space between the prism and the hologram mask, is provided in the supply part.

7. The exposure apparatus of claim 5, wherein the water supply device further includes a water level sensor disposed in the supply part to measure a level of water filling the supply part.

8. The exposure apparatus of claim 3, wherein the optical unit includes a sealing member disposed outside of the prism to prevent leakage of the water supplied to the space between the prism and the hologram mask.

9. The exposure apparatus of claim 8, wherein the sealing member is provided with a sealing part formed in a labyrinthine shape.

10. The exposure apparatus of claim 8, wherein the sealing member is provided with a positive pressure part, an inside of which maintains positive pressure, and
wherein the sealing member is provided with a positive pressure channel, to which positive pressure is transmitted, connected to an upper surface of the positive pressure part.

11. The exposure apparatus of claim 8, wherein the sealing member is provided with a negative pressure part, an inside of which maintains negative pressure.

12. The exposure apparatus of claim 11, wherein a negative pressure channel, to which negative pressure is transmitted, is connected to an upper surface of the negative pressure part, and
wherein a guide plane, extended to slope upwardly, is provided at one side of the negative pressure part located near the prism.

13. The exposure apparatus of claim 12, wherein an anti-wetting layer, including hydrophobic material, is provided on the guide plane.

14. An exposure apparatus, comprising:
a light source generating light;
a hologram mask, on which a hologram pattern is formed;
a prism, separated from the hologram mask, such that one surface of the prism is disposed opposite the hologram mask; and
a water supply device to supply water to a space between the prism and the hologram mask.

15. The exposure apparatus of claim 14, wherein the water supply device includes a storage chamber, located at a higher position than that of the space between the prism and the hologram mask, to supply the water to the space between the prism and the hologram mask due to a water head difference.

16. The exposure apparatus of claim 15, wherein the water supply device further includes a pump to supply water to the storage chamber, a division member to divide a lower space of the storage chamber into a storage part to store water and a supply part to allow water to be supplied to the space between the prism and the hologram mask due to the water head difference, and a water level sensor disposed in the supply part to measure a level of water filling the supply part.

17. The exposure apparatus of claim 14, further comprising:
an optical frame, in which the prism is mounted, movably disposed on the hologram mask; and
a sealing member disposed outside of the prism to prevent leakage of the water supplied to the space between the prism and the hologram mask.

18. The exposure apparatus of claim 17, wherein a sealing part formed in a labyrinthine shape, a positive pressure part, an inside of which maintains positive pressure, and a negative pressure part, an inside of which maintains negative pressure, are provided on one surface of the sealing member, disposed opposite the hologram mask and contacting the hologram mask.

19. The exposure apparatus of claim 18, wherein a positive pressure channel, to which positive pressure is transmitted, is connected to an upper surface of the positive pressure part,
wherein a negative pressure channel, to which negative pressure is transmitted, is connected to an upper surface of the negative pressure part, and
wherein a guide plane, extended to slope upwardly, is provided at one side of the negative pressure part located near the prism.

20. The exposure apparatus of claim 19, wherein an anti-wetting layer, including hydrophobic material, is provided on the guide plane.
